(19) United States
(12) Patent Application Publication
(10) Pub. No.: US 2025/0361912 A1
(43) Pub. Date: Nov. 27, 2025

(54) DRIVESHAFT ARRANGEMENT FOR A MOTOR VEHICLE

(71) Applicant: GKN Driveline International GmbH, Lohmar (DE)

(72) Inventors: Orkan Eryilmaz, Lohmar (DE); Thomas Weckerling, Lohmar (DE); Hans-Jürgen Post, Lohmar (DE); Darius Engel, Lohmar (DE)

(21) Appl. No.: 18/871,974

(22) PCT Filed: Mar. 15, 2023
(86) PCT No.: PCT/EP2023/056601

§ 371 Date: Dec. 5, 2024

(51) Int. Cl. F16D 3/205; B60K 17/22

(52) U.S. Cl. CPC F16D 3/2055; B60K 17/22

(57) ABSTRACT

A drive shaft assembly for a motor vehicle, has at least a first tripod joint having a first outer part and a first inner part having three first trunnions with first trunnion axes. A second sliding joint has a second outer part and a second inner part, and a connecting shaft which extends along an axial direction between a first end and a second end and which is connected in a torque-transmitting manner via the first end to the first tripod joint and via the second end to the second sliding joint. At least the trunnion axes of the first trunnions are inclined relative to a radial direction by a first angle of inclination which is greater than zero angular degree.

### TECHNICAL FIELD

The disclosure relates to a drive shaft arrangement for a motor vehicle. The drive shaft arrangement comprises at least a first tripod joint, a second sliding joint (which may be a second tripod joint) and a connecting shaft which extends along an axial direction between a first end and a second end and which is connected in a torque-transmitting manner to the first tripod joint via the first end and to the second sliding joint (or tripod joint) via the second end.

### BACKGROUND

A tripod joint is known in principle. It comprises an outer part with a first rotational axis and an inner part with a second rotational axis, the inner part having three trunnions. The outer part has a receptacle for the inner part, wherein the receptacle extends along the first rotational axis and has three raceways, which extend along the first rotational axis and are distributed in a circumferential direction. The inner part has a central body extending along the second rotational axis and the three trunnions, each having a trunnion axis and being arranged distributed in the circumferential direction, the trunnions extending from the central body at least along a radial direction. A roller body is arranged on each trunnion, with an inner circumferential surface contacting the trunnion and an outer circumferential surface contacting the respective raceway.

The inner part can be displaced along the first rotational axis relative to the outer part, with the roller bodies rolling in the respective raceway during the displacement.

At least the first tripod joint is a so-called GI joint. In a GI joint, the rolling element is formed by an annular body (which forms the outer circumferential surface) that is mounted directly on the trunnion by means of rolling elements (which form the inner circumferential surface). The roller body can also be mounted directly on the trunnion, so that in this case the annular body forms the outer circumferential surface on the one hand and the inner circumferential surface on the other, i.e. rolling elements are not provided in this case.

In particular, the outer circumferential surface extends coaxially to a roller body axis, wherein the roller body axis and the respective trunnion axis are tiltable relative to one another by an angle of at most three angular degrees.

In the case of a GI joint, the roller body is also tilted by the trunnion or the joint inner part relative to the raceways or the joint outer part.

In contrast, the roller body of a so-called AAR joint can be formed, for example, by an outer ring (which has the outer circumferential surface) and an inner ring (which has the inner circumferential surface) as well as rolling elements arranged in between. This means that the inner ring can at least rotate relative to the outer ring.

In an AAR joint, the roller body can be tilted relative to the trunnion, so that the roller body can only be rotated but not tilted in the raceways.

The properties of a tripod joint are also defined in particular by a so-called ACFG value (Axial Cyclic Force Generation, undesirable forces generated by the joint that act in an axial direction, also referred to as axial forces). This value is given as the root mean square of the force, with the unit Newton root mean square [Nrms]. The value varies in particular depending on the deflection angle of the joint, whereby the course of the value depending on the deflection angle can be defined or determined for each joint. The range of use of the joint is thus limited by a maximum angle of deflection at which the ACFG value does not exceed an amount still considered permissible. This ACFG value can be particularly high in the case of GI joints, due to the tilting of the roller body with respect to the joint outer part or the raceways.

From WO 95/12767 A1 and WO 97/02438 A1, tripod joints are known in which the trunnion axes are inclined with respect to the radial direction. This is intended to reduce the cyclic axial forces that arise when the joint is deflected.

In motor vehicles, drive shaft arrangements are used in particular to transmit torque from a drive unit to a wheel. Drive shaft arrangements are known for front-wheel and rear-wheel drive motor vehicles as well as for all-wheel drive motor vehicles. In order to compensate for movements of the wheel with respect to the components connected to the body of a motor vehicle, the drive shaft arrangements have constant-velocity universal joints or tripod joints and connecting shafts. The connecting shafts extend transversely to the longitudinal axis of a motor vehicle and essentially parallel to the front and/or rear axle of a motor vehicle (side shaft arrangement). In particular, each driven wheel has its own drive shaft arrangement. The connecting shaft can also be used to transmit torque in the longitudinal direction of the motor vehicle (longitudinal shaft arrangement).

Combustion engines, electric drives or fuel cell drives are regularly used as drive units. So-called hybrid drives are also used in some cases, i.e. combinations of the above-mentioned drive units. The drive shaft arrangements usually extend from a gearbox/transmission or differential in the direction of one wheel. The gearbox or differential is connected to the connecting shaft by a differential/transmission-side constant velocity joint or tripod joint. This connecting shaft is connected to the wheel by a wheel-side constant velocity joint or tripod joint. This arrangement of the constant velocity joints/tripod joints allows torques to be transmitted even when the wheel is swivelled in relation to the differential/transmission. Shifts in the axial direction of the connecting shaft can be compensated by constant-velocity joints in the form of sliding joints or by tripod joints. If sliding joints or tripod joints are arranged on both sides of the connecting shaft, the connecting shaft is said to “float”.

Various arrangements of sliding joints on such drive shaft arrangements with a floating connecting shaft are known from WO 2021/115817 A1.

In particular, the second sliding joint, if it is not designed as a tripod joint, can be designed, for example, as a constant velocity ball sliding joint, as described, for example, in WO 2021/115817 A1. In a constant velocity ball sliding joint, the outer part and the inner part each have ball tracks that form track pairs with each other. A ball is arranged in each pair of tracks.

When a drive shaft assembly is in operation, different cyclic axial forces can act on the floating connecting shaft stemming from the individual sliding joints. The cyclic axial forces generated by the respective sliding joint depend not only on its design (e.g. as a tripod joint and thus e.g. as a GI or AAR joint), but also in particular on the following factors: torque, angle of deflection (i.e. the angle between a rotational axis of the inner part and a rotational axis of the outer part of a respective joint), the rotational position of each joint (phase position) and the direction of the power flow (i.e. from the outer part to the inner part or from the inner part to the outer part).

A superimposition of these different cyclic axial forces of the sliding joints results in a resulting cyclic axial force on the connecting shaft. This resulting cyclic axial force on the connecting shaft may result in a cyclic motion of the connecting shaft in the axial direction.

This cyclic motion of the connecting shaft in the axial direction may, in particular, lead to the following problems:
undesirable noise generation, especially in the case of a resonance for the spring-mass system of the connecting shaft;
occurrence of fatigue fractures in rolling bellows or convoluted bellows of the joints;
striking of the inner part of a joint in the bottom of the outer part;
resilient elements are required to center the connecting shaft with respect to the axial direction between the joints, which are intended to ensure the positioning of the connecting shaft in the axial direction.

The object of at least some implementations of the present disclosure is to at least partially solve the problems mentioned with regard to the prior art. In particular, a drive shaft arrangement is to be proposed in which the superimposition of the cyclic axial forces of the individual joints may produce a resulting cyclic axial force on the connecting shaft that is as low as possible.

### SUMMARY

A drive shaft arrangement contributes to the solution of these tasks. Advantageous further developments are the subject of the dependent claims. The features individually listed in the claims can be combined with each other in a technologically meaningful way and can be supplemented by explanatory facts from the description and/or details from the figures, whereby further embodiments of the disclosure are shown.

A drive shaft assembly for a motor vehicle is proposed, comprising at least:
a first (GI) tripod joint having
   a first outer part with a first rotational axis;
   a first inner part with a second rotational axis, the first inner part having three first trunnions with first trunnion axes:
a second sliding joint (which may be a second tripod joint) having
   a second outer part with a third rotational axis and
   a second inner part with a fourth axis rotational of:
a connecting shaft which extends along an axial direction between a first end and a second end and which is connected or can be connected in a torque-transmitting manner to the first tripod joint via the first end and to the second sliding joint via the second end.

At least the first outer part has a receptacle for the first inner part, which extends along the first rotational axis, and three raceways, which extend along the first rotational axis and are distributed in a circumferential direction (each offset by 120 angular degrees from one another).

At least the first inner part has a central body extending along the second rotational axis and the three first trunnions, each having one of the first trunnion axes and being distributed in the circumferential direction (offset by 120 angular degrees relative to one another), which extend from the central body at least in a radial direction. The radial direction extends perpendicular to the second rotational axis of the inner part.

A roller body is arranged on each first trunnion, which roller body contacts the first trunnion with an inner circumferential surface and contacts the respective raceway with an outer circumferential surface which extends around a roller body axis. In particular, the outer circumferential surface (or part of it) may extend coaxially with the roller body axis. In particular, the roller body axis and the respective first trunnion axis may be tiltable relative to one another by an angle of at most three angular degrees, or by at most one angular degree.

At least the first tripod joint may be therefore a so-called GI joint. In a GI joint, the roller body is formed by an annular body (which forms the outer circumferential surface) that is mounted directly on the trunnion via rolling elements (which form the inner circumferential surface). The roller body can also be mounted directly on the trunnion, so that in this case the annular body forms the outer circumferential surface on the one hand and the inner circumferential surface on the other, i.e. rolling elements are not provided in this case.

In a GI joint, the roller body is tilted by the trunnion or the inner joint part relative to the raceways or the outer joint part. The roller body is tiltable relative to the trunnion axis only slightly (less than three or even less than one angular degree).

In the drive shaft arrangement, the trunnion axes of the first trunnions (or, if the second joint is also a tripod joint, the trunnion axes of the second trunnions) are inclined at an angle of inclination greater than zero angular degrees with respect to the radial direction.

It has been shown that, in particular in the case of floating drive shaft arrangements in which at least the one sliding joint is designed as a GI tripod joint, the axial forces occurring during operation can be further reduced by the trunnion axes being arranged at an inclination. It has also been shown that a particularly strong reduction in the axial forces can be achieved in certain designs of the drive shaft arrangement.

The drive shaft assembly may include a set of a first (GI) tripod joint, a second sliding joint (which may be designed as a tripod joint and as a GI tripod joint) and a connecting shaft, these components being designed so that the joints can be connected (directly or indirectly) in a torque-transmitting manner by means of the connecting shaft (kit). The drive shaft arrangement may include the first tripod joint, the second sliding joint (which may be designed as a tripod joint) and the connecting shaft, by means of which the joints are connected (directly or indirectly) in a torque-transmitting manner (assembled or installed state). The joints are each sliding joints, i.e. the inner part can slide along the rotational axis of the outer part relative to the outer part.

In particular, the second sliding joint may be designed as a constant velocity ball sliding joint, as described for example in WO 2021/115817 A1. In a constant velocity ball sliding joint, the outer part and inner part each have ball tracks that form track pairs with each other. A ball is arranged in each track pair.

The joints of the drive shaft assembly are sliding joints, i.e. the inner part can slide relative to the outer part in the axial direction. The sliding distance is at least 3.0 mm [millimeters] in each direction, starting from the position of the inner part and outer part in which the rolling elements of the joint (balls or rollers) lie in a joint center plane. Thus, the total travel is at least 6.0 mm. The total travel may be at least 10.0 mm.

More particularly, the second sliding joint may be a second tripod joint having
a second outer member having a third rotational axis, and
a second inner part having a fourth rotational axis, the second inner part having three second trunnions with second trunnion axes.

The connecting shaft, which extends along an axial direction between the first end and the second end, is connectable or connected in a torque-transmitting manner to the first tripod joint via the first end and to the second tripod joint via the second end.

As with the first outer part, the second outer part also has a receptacle for the second inner part extending along the third rotational axis, as well as three raceways extending along the respective rotational axis and distributed in a circumferential direction (offset from one another by 120 angular degrees).

As with the first inner part, the second inner part also has a central body extending along the fourth rotational axis and the three second trunnions, each having one of the second trunnion axes and distributed in the circumferential direction (offset by 120 angular degrees relative to each other), which extend from the central body at least in a radial direction. The radial direction extends perpendicular to the fourth rotational axis of the second inner part.

A roller body is arranged on each second trunnion, which contacts the second trunnion with an inner circumferential surface and the respective raceway with an outer circumferential surface.

The second tripod joint can be designed, for example, as an AAR tripod joint or as a GI tripod joint. In particular, however, the second tripod joint may be a GI tripod joint, in which a roller body is arranged on each second trunnion, contacting the second trunnion with an inner circumferential surface and contacting the respective raceway with an outer circumferential surface extending around a roller body axis. In particular, the outer circumferential surface (or part of it) may extend coaxially with the roller body axis. In particular, the roller body axis and the respective second trunnion axis may be tiltable relative to one another by an angle of at most three angular degrees, which may be by an angle of at most one angular degree.

In the drive shaft arrangement, at least the trunnion axes of the first trunnions or the second trunnions (or both trunnions) are inclined at an inclination angle with respect to the radial direction, the absolute value of which is greater than zero angular degrees.

At least one tripod joint of the drive shaft arrangement is now designed such that the trunnion axes of the trunnions are inclined at an inclination angle to the radial direction. The inclination angle of all trunnion axes of a tripod joint is the same in each case.

The angle of inclination may be determined between the trunnion axis and the radial direction, which extends perpendicular to the rotational axis of the inner part. Typically, this angle of inclination is zero angular degrees.

In particular, the angle of inclination may extend (exclusively) in a plane that includes the rotational axis of the respective inner part: the absolute value of the angle of inclination being between 2 and 10 angular degrees, which may be between 3 and 9 angular degrees, or between 4 and 8 angular degrees. In particular, a slight deviation of the position of the trunnion axis from the aforementioned plane may be possible, e.g. by a maximum of five angular degrees, which may be by a maximum of two angular degrees, or by a maximum of one angular degree.

In particular, the first trunnion axes may be inclined by a first angle of inclination and the second trunnion axes are inclined by a second angle of inclination with respect to the radial direction, i.e. in each case by an angle of inclination whose absolute value is greater than zero angular degrees.

In particular, for an inclination angle being positive, the trunnion axes may extend from the central body towards the other tripod joint.

In particular, for an inclination angle being negative, the trunnion axes may extend from the central body away from the other tripod joint.

In particular, the first inclination angle may have a positive value and the second inclination angle has a negative value, or all inclination angles have a positive or a negative value. In any case, the inclination angle is not equal to zero.

In particular, the first inclination angles and the second inclination angles may have the same absolute value or have different absolute values.

In particular, the first tripod joint may have a first phase angle with respect to the circumferential direction determined by the first trunnion axes and the second sliding joint (or the second tripod joint) has a second phase angle determined by the second trunnion axes. In particular, the joints may be arranged in the drive shaft arrangement or on the connecting shaft with phase angles offset with respect to each other in the circumferential direction.

In particular, the offset of the phase angles may be between 150 and 210 angular degrees, or between 160 and 200 angular degrees. In particular, the offset of the phase angles may be 180 angular degrees (with a maximum deviation of two angular degrees as permissible tolerance).

Each joint of the drive shaft assembly can, in particular, have a certain phase angle (rotational position or angle of rotation, zero to 360 angular degrees). The phase angle is determined by the position of the roller bodies (or balls) or the raceways in relation to a circumferential direction. The phase angle is the same for an outer part and an inner part of a joint, since these parts are arranged in a form-fitting manner over the roller bodies in the circumferential direction. In particular, different cyclic axial forces may be produced if the joints have different phase angles (and if there is a deflection angle greater than zero between the rotational axes of the inner parts and the outer parts). For example, in the case of identically constructed joints, the phase angle of the joints is the same if the same joints are arranged identically in relation to a circumferential direction (i.e. if, in a coaxial arrangement of the rotational axes and the axial direction, the raceways or roller bodies (or balls) are aligned with each other in the axial direction).

In particular, the cyclic axial forces may be caused by friction between the roller bodies (balls) and the raceways. The forces that occur vary over a rotation of the joint around the rotational axis by 360 angular degrees. The friction may be dependent on the design of the joint, the applied torque, the rotational speed and the deflection angle.

High cyclic axial forces may occur in GI tripod joints. However, the use of such GI tripod joints is desired because they can be produced particularly inexpensively. The drive shaft arrangement described here can effectively reduce the cyclic axial forces that occur during operation.

In particular, each joint may have a certain phase angle of the outer part and the inner part relative to a circumferential direction, wherein a first phase angle of the first joint and a second phase angle of the second joint are set such that cyclic axial forces occurring at each joint and acting on the connecting shaft during operation of the drive shaft arrangement cancel each other out as far as possible.

The phase angles of the joints of the drive shaft arrangement do not change during operation of the drive shaft arrangement, but are permanently fixed. In particular, a phase angle may only be set with a certain tolerance. This tolerance can be caused, for example, by a spline between the connecting shaft and the respective joint parts that are connected to the ends of the connecting shaft. In this case, the joint part arranged at the end of the connecting shaft can be arranged so that it is rotatably offset by at least one tooth of the spline in relation to the connecting shaft.

If the offset of the phase angles is 180 angular degrees, a first trunnion axis extends vertically upwards (angular position of zero degrees) and a second trunnion axis extends vertically downwards. In other words, if, for example, both joints are designed as tripod joints, the trunnion axes of the two tripod joints are each rotated 60 angular degrees relative to one another.

In particular, the first tripod joint and the second tripod joint may be arranged in the drive shaft arrangement with an equal orientation, so that the connecting shaft is connected at one end to one of the outer parts and at the other end to one of the inner parts.

In particular, the first tripod joint and the second tripod joint may be arranged in the drive shaft arrangement with a different orientation, so that the connecting shaft is connected at both ends to the outer parts or at both ends to the inner parts.

The tripod joints may be arranged on the connecting shaft with the same alignment, so that the power flow is from the first outer part via the first inner part to the connecting shaft and via the second outer part to the second inner part, for example: or alternatively from the first inner part via the first outer part to the connecting shaft and via the second outer part to the second inner part.

The connecting shaft may extend transversely to the longitudinal axis of a motor vehicle and essentially parallel to the front and/or rear axle of a motor vehicle (side shaft arrangement). In particular, each driven wheel may have its own drive shaft arrangement. The connecting shaft can also be used to transmit torque in the longitudinal direction of the motor vehicle (longitudinal shaft arrangement).

The drive shaft arrangement may be a longitudinal shaft arrangement or a side shaft arrangement. As a side shaft arrangement, the drive shaft arrangement may be intended for a rear axle, in which smaller steering angles occur than on a front axle.

In particular, the connecting shaft may be positioned with respect to the axial direction by means of at least one elastically resilient element between the joints. In particular, the connecting shaft may be connectable or connected to at least one of the (tripod) joints by means of at least one elastically resilient element with respect to the axial direction.

The resilient element may, for example, be a spring arranged between the inner part and the outer part within the joint. Alternatively or additionally, the resilient element may be realized by means of a sealing element, for example a thermoplastic sealing element, for example a rolling bellows or a (diaphragm) folding bellows.

The connecting shaft can be displaced along the axial direction relative to the at least one (tripod) joint by means of the at least one resilient element, with the element deforming elastically in the process.

Furthermore, a motor vehicle is proposed, at least comprising at least one drive unit and a plurality of wheels, wherein at least one wheel is drivable via the drive unit. At least the drive shaft arrangement described is arranged between the drive unit and at least one of the wheels.

In particular, each of the wheels may be driven by the at least one drive unit. In particular, each wheel may be connected in a torque-transmitting manner to the at least one drive unit via a respective one of the drive shaft arrangements.

The explanations regarding the drive shaft arrangement can be transferred in particular to the motor vehicle and vice versa.

As a precaution, it should be noted that the words used here (“first”, “second”, . . . ) primarily serve to distinguish between several similar objects, sizes or processes, and thus in particular do not necessarily imply any dependency and/or sequence of these objects, sizes or processes in relation to one another. If a dependency and/or sequence is required, this is explicitly stated here or it is obvious to a person skilled in the art when studying the specifically described design. If a component can occur more than once (“at least one”), the description of one of these components can apply equally to all or some of the majority of these components, but this is not mandatory.

The use of indefinite articles (“a”, “an”), in particular in the claims and the description reproducing them, is to be understood as such and not as a numeral. Accordingly, terms or components introduced with them are to be understood as meaning that they are present at least once and, in particular, may also be present multiple times.

### BRIEF DESCRIPTION OF THE DRAWINGS

The disclosure and the technical environment will be explained in more detail below using the attached figures. It should be noted that the disclosure is not to be limited by the cited examples. In particular, unless explicitly stated otherwise, it is also possible to extract partial aspects of the facts explained in the figures and to combine them with other components and findings from the present description. In particular, it should be noted that the figures and in particular the proportions shown are only schematic. Showing:

FIG. 1 a known deflected GI tripod joint in a view along the first rotational axis, partly in section;

FIG. 2 a further known GI tripod joint in a side view in section;

FIG. 3 a motor vehicle;

FIG. 4 various designs of a drive shaft arrangement in a motor vehicle;

FIG. 5 a drive shaft arrangement and the phase positions of the joints;

FIG. 6 course of the resulting cyclic axial force of the drive shaft arrangement according to FIG. 5;

FIG. 7 a drive shaft arrangement;

FIG. 8 course of the resultant cyclic axial force of the drive shaft arrangement according to FIG. 7;

FIG. 9 an inner part of a GI tripod joint in a side view, partly in section;

FIG. 10 the inner part according to FIG. 9 with roller body and cut-away trunnion; and

FIG. 11 a GI tripod joint in a side view in section.

### DETAILED DESCRIPTION

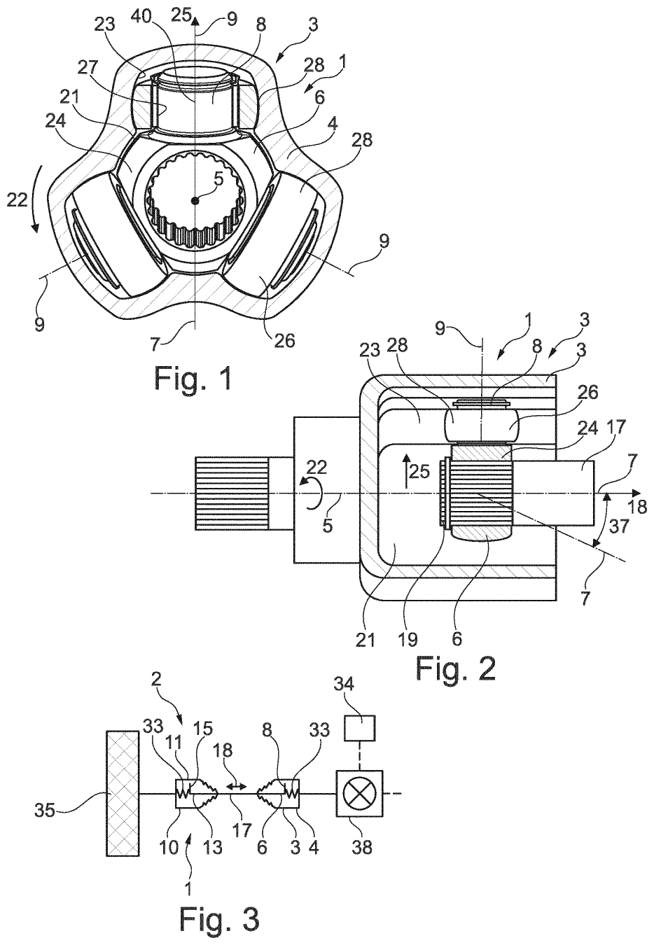

FIG. 1 shows a known deflected GI tripod joint 3 in a view along the first trunnion axis 5, partly in section. FIG. 2 shows another known GI tripod joint 3 (in an extended position, i.e. with a deflection angle of 37 zero angular degrees) in a side view in section. FIGS. 1 and 2 are described together below.

The tripod joint 3 comprises an outer part 4 with a first rotational axis 5 and an inner part 6 with a second rotational axis 7, the inner part 6 having three trunnions 8. The outer part 4 has a receptacle 21 for the inner part 6, which receptacle extends along the first rotational axis 5, and three raceways 23 which extend along the first rotational axis 5 and are arranged distributed in a circumferential direction 22. The inner part 6 has a central body 24 extending along the second rotational axis 7 and the three trunnions 8, each having a trunnion axis 9 and arranged distributed in the circumferential direction 22, which, starting from the central body 24, extend exclusively along a radial direction 25. A roller body 26 is arranged on each trunnion 8, which contacts the trunnion 8 with an inner circumferential surface 27 and contacts the respective raceway 23 with an outer circumferential surface 28.

The tripod joint 3 is a so-called GI joint, in which the roller body 26 is formed by an annular body, which forms the outer circumferential surface 28, and is mounted directly on the trunnion 8 by means of rolling elements, which form the inner circumferential surface 27. The outer circumferential surface 28 extends coaxially to a roller body axis 40, wherein the roller body axis 40 and the respective trunnion axis 9 can be tilted with respect to one another by an angle of at most three angular degrees (here an angle of zero angular degrees is shown).

In a GI joint, the roller body 26 is tilted by the trunnion 8 or by the inner part 6 with respect to the raceways 23 or the outer part 4.

In FIG. 2, the angle of deflection 37 between the first rotational axis 5 and the second rotational axis 7, which is only present in FIG. 1, is only indicated.

FIG. 3 shows a motor vehicle 2 with a drive shaft arrangement 1. The drive shaft arrangement 1 is designed as a side shaft arrangement.

The drive shaft arrangement 1 extends from a differential 38 in the direction of a wheel 35. The differential 38 is connected to a drive unit 34 via an indicated drive shaft. The differential 38 is connected to a connecting shaft 17 via a differential-side first tripod joint 3. This connecting shaft 17 is connected to the wheel 35 via a wheel-side second tripod joint 10. This arrangement of the joints 3, 10 allows torques to be transmitted even when the wheel 35 is swivelled with respect to the differential 38. Displacements in the axial direction 18 of the connecting shaft 17 can be compensated by the tripod joints 3, 10. Tripod joints 3, 10 are arranged on both sides of the connecting shaft 17, so that the connecting shaft 17 is arranged in a floating manner (i.e. can be displaced in the axial direction 18 via both joints 3, 10).

The second outer part 11 of the wheel-side second tripod joint 10 is connected to a second connection shaft and transmits torque to the wheel 35. A first connection shaft is connected to the first outer part 4 of the differential-side first tripod joint 3 and transmits the torque of the first connection shaft to the connecting shaft 17.

A power flow via the drive shaft arrangement 1 with the joints 3, 10 aligned in such different ways is thus effected starting from the first outer part 4 of the first tripod joint 3 via the first inner part 6 to the connecting shaft 17 and via the second inner part 13 of the second tripod joint 10 to the second outer part 11.

The connecting shaft 17 is positioned relative to the axial direction 18 by means of a respective elastically resilient element 33 between the tripod joints 3, 10.

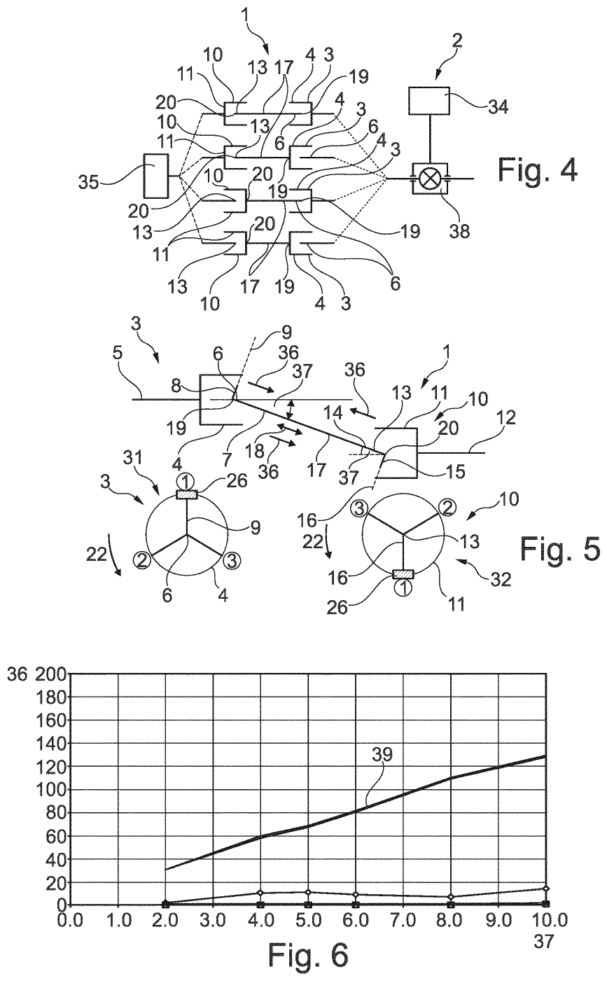

FIG. 4 shows various configurations of a drive shaft arrangement 1 in a motor vehicle 2. Reference is made to the explanations relating to FIGS. 1 to 3.

In the center configuration, the first tripod joint 3 and the second tripod joint 10 are arranged in the driveshaft arrangement 1 with an equal orientation, so that the connecting shaft 17 is connected at one end 19, 20 to one of the outer parts 4, 11 and at the other end 20, 19 to one of the inner parts 6, 13.

In the upper and lower configurations, the first tripod joint 3 and the second tripod joint 10 are arranged in the drive shaft arrangement 1 with a different orientation, so that the connecting shaft 17 is connected at both ends ends 19, 20 to the outer parts 4, 11 (lower configuration) or at both ends 19, 20 to the inner parts 6, 13 (upper configuration).

FIG. 5 shows a drive shaft arrangement 1 and the phase positions 31, 32 of the tripod joints 3, 10. Reference is made to the explanations for FIGS. 1 to 4.

The rotational axes 5, 7, 12, 14 of the individual tripod joints 3, 10 are each deflected by the angle of deflection 37.

The first tripod joint 3 has a first phase angle 31 determined with respect to the circumferential direction 22 by the first trunnion axes 9, and the second tripod joint 10 has a second phase angle 32 determined by the second trunnion axes 16. The tripod joints 3, 10 are arranged with phase angles 31, 32 offset by 180 angular degrees with respect to one another in the circumferential direction 22 in the drive shaft arrangement 1 or on the connecting shaft 17.

The phase position 31, 32 is determined by a position of the trunnion axes 9, 16 or the roller bodies 26 and the raceways 23 with respect to the circumferential direction 22. In this case, the phase position 31, 32 is the same for an outer part 4, 11 and an inner part 6, 13 of a tripod joint 3, 10, the phase angle 31, 32 is the same in each case, since these parts are arranged in a form-fitting manner with respect to one another via the roller bodies 26 in the circumferential direction 22.

The first phase angle 31 of the first tripod joint 3 is zero angular degrees. The second phase angle 32 of the second tripod joint 10 is 180 angular degrees. The offset of the phase angles 31, 32 is therefore 180 angular degrees. So here a first trunnion axis 9 extends vertically upwards (angular position zero degrees) and a second trunnion axis 16 extends vertically downwards. In other words, the trunnion axes 9, 16 of the two tripod joints 3, 10 are each rotated by 60 angular degrees relative to one another.

FIG. 6 shows the course 39 of the resulting cyclic axial force 36 of the drive shaft arrangement 1 according to FIG. 5. The horizontal axis of the diagram shows the deflection angle 37 in angular degrees. The vertical axis of the diagram shows the axial force 36 in the unit Newton root mean square [Nrms].

It can be seen that the resulting axial forces 36 increase steadily with increasing deflection angle 37.

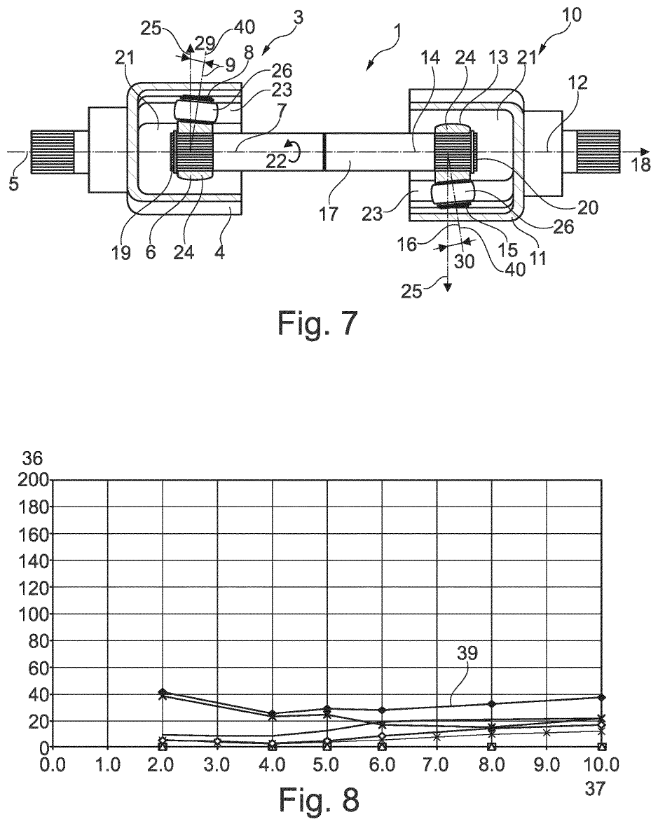

FIG. 7 shows a drive shaft arrangement 1. Reference is made to the explanations relating to FIGS. 1 to 6.

The drive shaft arrangement 1 comprises a first GI tripod joint 3 having a first outer part 4 with a first rotational axis 5 and having a first inner part 6 with a second rotational axis 7, the first inner part 6 having three first trunnions 8 with first trunnion axes 9.

Furthermore, the drive shaft assembly 1 comprises a second GI tripod joint 10 having a second outer part 11 with a third trunnion axis 12 and having a second inner part 13 with a fourth trunnion axis 14, the second inner part 13 having three second trunnions 15 with second trunnion axes 16.

The drive shaft assembly 1 further comprises a connecting shaft 17 which extends along an axial direction 18 between a first end 19 and a second end 20 and which is connected in a torque-transmitting manner to the first tripod joint 3 via the first end 19 and to the second tripod joint 10 via the second end 20.

Each of the outer parts 4, 11 has a receptacle 21, extending along the respective rotational axis 5, 12, for the respective inner part 6, 13, and three raceways 23, extending along the respective rotational axis 5, 12 and arranged distributed in a circumferential direction 22 (each offset by 120 angular degrees relative to one another).

Each of the inner parts 6, 13 has a central body 24 extending along the respective rotational axis 7, 14 and the three trunnions 8, 15, each having one of the trunnion axes 9, 16 and being distributed along the circumferential direction 22 (offset from one another by 120 angular degrees), which, starting from the central body 24, extend at least along a radial direction 25. The radial direction 25 extends perpendicular to the rotational axis 7, 14 of the respective inner part 6, 13.

A roller body 26 is arranged on each trunnion 8, 15, which contacts the trunnion 8, 15 with an inner circumferential surface 27 and contacts the respective raceway 23 with an outer circumferential surface 28.

The tripod joints 3, 10 are each designed as a so-called GI joint, in which the roller body 26 is formed by an annular body, which forms the outer circumferential surface 28, and is mounted directly on the trunnion 8, 15 via rolling elements, which form the inner circumferential surface 27. The outer circumferential surface 28 extends coaxially to a roller body axis 40, wherein the roller body axis 40 and the respective trunnion axis 9, 16 can be tilted relative to one another by an angle of at most three angular degrees (here an angle of zero angular degrees is shown).

In a GI joint, the roller body 26 is also tilted by the trunnion 8, 15 or by the inner part 6, 13 relative to the raceways 23 or the outer part 4, 11.

In drive shaft arrangement 1, the first trunnion axes 9 of the first trunnions 8 and also the second trunnion axes 16 of the second trunnions 15 are inclined at an angle of inclination 29, 30, whose absolute value is greater than zero angular degrees, with respect to the radial direction 25. The angle of inclination 29, 30 of all trunnion axes 9, 16 of a tripod joint 3, 10 is the same in each case.

The angle of inclination 29, 30 is determined between the trunnion axis 9, 16 and the radial direction 25, which extends perpendicular to the rotational axis 7, 14 of the inner part 6, 13.

The angle of inclination 29, 30 extends exclusively in a plane that encompasses the rotational axis 7, 14 of the respective inner part 6, 13. The absolute value of the angles of inclination 29, 30 is approximately 5 angular degrees.

The first trunnion axes 9 are inclined by a first angle of inclination 29 and the second trunnion axes 16 are inclined by a second angle of inclination 30 with respect to the radial direction 25, that is to say they are each inclined by an angle of inclination 29, 30 whose absolute value is greater than zero angular degrees.

At a positive inclination angle 29, 30, the trunnion axes 9, 16, starting from the central body 24, incline towards the other tripod joint 3, 10 (here at the first tripod joint 3).

At a negative inclination angle 29, 30, the trunnion axes 9, 16, starting from the central body 24, incline away from the other tripod joint 3, 10 (here at the second tripod joint 10).

The first inclination angle 29 therefore has a positive value and the second inclination angle 30 has a negative value.

The first inclination angles 29 and the second inclination angles 30 are equal in absolute value.

The first phase angle 31 of the first tripod joint 3 is zero angular degrees. The second phase angle 32 of the second tripod joint 10 is 180 angular degrees. The offset of the phase angles 31, 32 is therefore 180 angular degrees.

FIG. 8 shows the course 39 of the resulting cyclic axial force 36 of the drive shaft arrangement 1 according to FIG. 7. The deflection angle 37 is plotted on the horizontal axis of the diagram in angular degrees. The axial force 36 is plotted on the vertical axis of the diagram in newtons root mean square [Nrms].

It can be seen that the resulting axial forces 36 remain almost constant as the deflection angle 37 increases. The resulting axial forces 36 are significantly lower at larger deflection angles 37 than in the case of known drive shaft arrangements 1 (see FIG. 6).

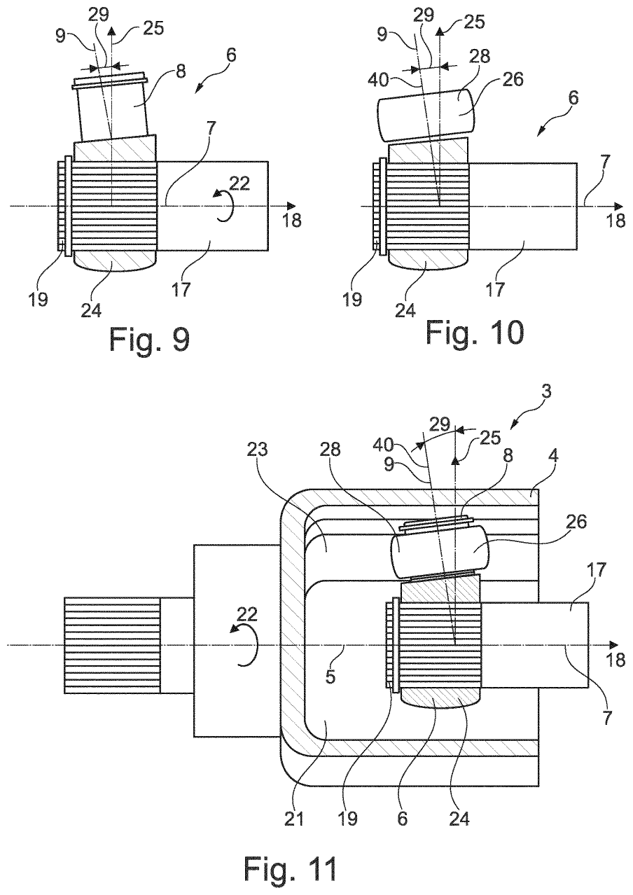

FIG. 9 shows a side view of an inner part 6 of a GI tripod joint 3, partly in section. FIG. 10 shows the inner part 6 according to FIG. 9 with roller body 26 and cut-away trunnion 8. FIG. 11 shows a GI tripod joint 3 in a side view in section. FIGS. 9 to 11 are described together in the following. Reference is made to the explanations for FIGS. 1 to 8.

The inner part 6 has a central body 24 extending along the second rotational axis 7, as well as the three trunnions 8, each having one of the trunnion axes 9 and being arranged distributed in the circumferential direction 22 (offset from one another by 120 angular degrees), which, starting from the central body 24, extend at least along a radial direction 25. The radial direction 25 extends perpendicular to the axis rotational 7 of the inner part 6.

A roller body 26 is arranged on each trunnion 8, the roller body 26 contacts the trunnion 8, 15 with an inner circumferential surface 27 and the respective raceway 23 with an outer circumferential surface 28.

The tripod joint 3 is designed as a so-called GI joint, in which the roller body 26 is formed by an annular body, which forms the outer circumferential surface 28, and is mounted directly on the trunnion 8 via rolling elements, which form the inner circumferential surface 27. The outer circumferential surface 28 extends coaxially to a roller body axis 40, wherein the roller body axis 40 and the respective trunnion axis 9 can be tilted relative to one another by an angle of at most three angular degrees (here a tilting at an angle of zero angular degrees is shown).

In a GI joint, the roller body 26 is tilted by the trunnion 8 or by the inner part 6 with respect to the raceways 23 or the outer part 4.

The trunnion axes 9 of the trunnions 8 are inclined at an angle of inclination 29 with respect to the radial direction 25, the absolute value of which is greater than zero angular degrees. The angle of inclination 29 of all trunnion axes 9, 16 of a tripod joint 3 is the same in each case.

The angle of inclination 29 is determined between the trunnion axis 9 and the radial direction 25, which extends perpendicular to the rotational axis 7 of the inner part 6.

The angle of inclination 29 extends exclusively in a plane that encompasses the rotational axis 7 of the inner part 6. The absolute value of the angle of inclination 29 is approximately 5 angular degrees.

1. A drive shaft assembly for a motor vehicle, comprising at least:
a first tripod joint with
a first outer part with a first rotational axis
a first inner part with a second rotational axis, the first inner part having three first trunnions with first trunnion axes;
a second sliding joint with
a second outer part with a third rotational axis and
a second inner part with a fourth rotational axis, which is displaceable along the third rotational axis with respect to the second outer part;
a connecting shaft which extends along an axial direction between a first end and a second end and which is connectable or connected via the first end to the first tripod joint and via the second end to the second sliding joint in a torque-transmitting manner;
wherein the first outer part has a receptacle for the first inner part, which receptacle extends along the first rotational axis, and has three raceways which extend along the first rotational axis and are arranged so as to be distributed in a circumferential direction; wherein the first inner inner part comprises a central body extending along the second rotational axis and the three first trunnions each comprising one of the first trunnion axes and arranged distributed in the circumferential direction, which first trunnions extend, starting from the central body, at least along a radial direction, wherein the radial direction extends perpendicular to the second rotational axis of the first inner part; wherein a roller body is arranged on each first trunnion, which roller body contacts the first trunnion with an inner circumferential surface and contacts the respective raceway by means of an outer circumferential surface extending around a roller body axis; wherein the roller body axis and the respective first trunnion axis are tiltable with respect to each other by an angle of at most three angular degrees;
wherein that the first trunnion axes of the first trunnions are inclined relative to the radial direction by a first angle of inclination whose absolute value is greater than zero angular degrees.

2. The drive shaft assembly according to claim 1, wherein the first inclination angle extends in a plane that includes the second rotational axis of the first inner part; wherein an absolute value of the first inclination angle is between 2 and 10 angular degrees.

3. The drive shaft assembly according to claim 1, wherein the second joint is a tripod joint, wherein the second inner part has three second trunnions with second trunnion axes; wherein the second outer part has a receptacle for the second inner part, which receptacle extends along the third rotational axis, and has three raceways which extend along the third rotational axis and are arranged distributed in a circumferential direction; the second inner part having a central body extending along the fourth rotational axis and the three second trunnions each having one of the second trunnion axes and arranged distributed in the circumferential direction, which second trunnions extend, starting from the central body, at least along a radial direction, the radial direction extending perpendicularly to the fourth rotational axis of the respective inner part; wherein a roller body is arranged on each of the second trunnions, which roller body is in contact with the second trunnion by means of an inner circumferential surface and is in contact with the respective raceway by means of an outer circumferential surface extending around a roller body axis; wherein the roller body axis and the respective second trunnion axis are tiltable relative to one another by an angle of at most three angular degrees.

4. The drive shaft assembly according to claim 3, wherein the second trunnion axes of the second trunnions are inclined relative to the radial direction by a second inclination angle whose absolute value is greater than zero angular degrees.

5. The drive shaft assembly according to claim 4, wherein the second inclination angle extends in a plane that includes the fourth rotational axis of the second inner part; wherein an absolute value of the second inclination angle is between 2 and 10 angular degrees.

6. The drive shaft arrangement according to claim 4, wherein, with a positive angle of inclination, the trunnion axes incline from the central body towards the other tripod joint in each case; the first angle of inclination having a positive value and the second angle of inclination having a negative value or all angles of inclination having a positive or a negative value.

7. The drive shaft arrangement according to claim 4, wherein the first angles of inclination and the second angles of inclination are equal in absolute value or have different angular absolute values from one another.

8. The drive shaft arrangement according to claim 3, wherein the first tripod joint has a first phase angle determined with respect to the circumferential direction by the first trunnion axes and the second tripod joint has a second phase angle determined by the second trunnion axes; the tripod joints being arranged with phase angles offset with respect to one another in the circumferential direction.

9. The drive shaft arrangement according to claim 8, wherein the offset of the phase angles is between 150 and 210 angular degrees.

10. The drive shaft arrangement according to claim 3, wherein the first tripod joint and the second tripod joint can be arranged or are arranged in the drive shaft arrangement with an identical alignment so that the connecting shaft is connectable or connected at one end to one of the outer parts and at the other end to one of the inner parts.

11. The drive shaft arrangement according to claim 3, wherein the first tripod joint and the second tripod joint are arrangeable or are arranged in the drive shaft arrangement with a different orientation so that the connecting shaft is connectable or connected at both ends to the outer parts or at both ends to the inner parts.

12. The drive shaft arrangement according to claim 3, wherein the connecting shaft is connectable or is connected to at least one of the tripod joints via at least one element elastically resilient with respect to the axial direction.

13. The drive shaft arrangement according to claim 1, wherein the drive shaft arrangement is a longitudinal shaft arrangement or a side shaft arrangement.

14. A motor vehicle comprising at least one drive unit and a plurality of wheels, wherein at least one wheel is drivable by the drive unit; wherein at least one drive shaft arrangement according to claim 1 is arranged between the drive unit and at least one of the wheels.

15. The motor vehicle according to claim 14, wherein each of the wheels is drivable via the at least one drive unit; wherein each wheel is connected in a torque-transmitting manner to the at least one drive unit via a respective one of the drive shaft arrangements.
